(19) United States
(12) Patent Application Publication
(10) Pub. No.: US 2008/0027161 A1
(43) Pub. Date: Jan. 31, 2008

(54) Highly Filled Polyolefin Compounds

(75) Inventors: Thomas Schlosser, Inzlingen (DE); Aristidis Ioannidis, Rheinfelden (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Degussa AG, Duesseldorf (DE)

(21) Appl. No.: 10/588,850

(22) PCT Filed: Dec. 17, 2004
(86) PCT No.: PCT/EP04/53578

§ 371 Date: May 17, 2007

(30) Foreign Application Priority Data
Feb. 13, 2004 (DE) 10 2004 007 456.9

(51) Int. Cl. C08K 5/544; C08L 23/06; H01B 3/44

(52) U.S. Cl. 524/188; 427/369

(57) ABSTRACT

The present invention relates to highly filled polyolefin compounds, the preparation of which uses maleic-anhydride-modified polyolefin and at least one amino-functional silicon compound, and to a process for their preparation, and to their use.

The present invention relates to highly filled polyolefin compounds, to their preparation, and also to their use, where the polyolefin matrix of the compounds is based on polyethylene (PE), on polypropylene (PP), on ethylene-propylene rubber (EPM), on ethylene-propylene-diene terpolymers (EPDM), or on their copolymers, or on mixtures of abovementioned polyolefins.

It is known that fillers can be incorporated into polymers. The reinforcing, flame-retardant, or else extending action of these fillers on the filled compounds and the final product, e.g. cable insulation, provide the motives for this procedure, a further reason being the controlled modification of mechanical properties of the polymer.

Aminosilanes, e.g. DYNASYLAN® AMEO, have long been used to permit achievement of a very high level of mechanical properties even at a high filler level (U.S. Pat. No. 3 843 591, EP 0 136 540 B1).

EP 0 518 057 B1 discloses mixtures of vinyl/alkyl/alkoxy-containing siloxanes which are used as crosslinking agents for thermoplastic polyolefins.

Mixtures of aminopropyl/alkoxy/alkyl-functional siloxane oligomers are found in EP 0 997 469 A2, and the mixtures here are used, inter alia, as adhesion promoters in filled thermoplastic compounds, in the coating of glass fibers, or else for the silanization of fillers and of pigments.

EP 0 953 591 B1 relates to stable compositions of water-soluble amino- and alkenyl-functional organosiloxanes, their preparation, and use for modifying the properties of pigments and of fillers, such as aluminum oxide, magnesium oxide, silica, chalk, gypsum, baryte, glass fibers, glass beads, carbon black, wollastonite, kaolin, mica, talc—to mention just a few.

The use of functional organylorganyloxysilanes or of their cocondensates on support materials in compounds for cables is found in EP 1 063 655 A1.

An important requirement within ISO 6722 is the aging test on automobile cables over a period of 3000 hours at 125° C. (temperature class C). Various technical systems currently meet these demands. As an alternative to filled and crosslinked insulating sheath mixtures, use is also made of thermoplastic and filled compounds based on polypropylene (PP) and polyethylene (PE). In order to ensure effective promotion of adhesion between flame-retardant filler and non-polar polymer, a polar adhesion promoter is added to the polymer. The use of maleic-anhydride-modified (MAH-modified) polyolefin as compatibilizer between non-polar polymer matrix and the relatively polar filler generally gives not only advantages in processing but also better mechanical properties of the compounds, and therefore of the cable materials. For this, up to about 15% of the polymer content used in the compounds has to take the form of MAH-grafted polyolefin.

The object on which the invention was based was then to provide other highly filled compounded polyolefin materials.

According to the invention, the object is achieved as stated in the claims.

Surprisingly, it has now been found that the additional use of at least one amino-functional silane system during the preparation of a highly filled polyolefin compounds, in particular when this is based on PE, PP, EPM or else EPDM, and comprises maleic-anhydride-modified, i.e. MAH-grafted, polymer, can significantly reduce the melt viscosity of the compositions, thus indicating considerably better dispersion of the filler in the polymer matrix. The results of this are not only lower loading on machinery and high-quality extrudate surfaces but also improved mechanical properties of the resultant highly filled compounds. In this context particular emphasis should also be given to the significantly increased tensile strain at break of compounds thus obtained. The use of amino-functional silicon compounds during the preparation of said polyolefin compounds moreover permitted the achievement of an increased level of hydrophobic properties in the molding composition, and thus to substantially lower water absorption and resultant improved electrical properties in the final products. It was also found that the use of amino-functional silicon compounds can reduce the proportion of MAH-grafted polyolefin in the compounds in a simple and cost-effective manner.

The present invention therefore provides highly filled polyolefin compounds, the preparation of which uses a combination of maleic-anhydride-modified polyolefin and at least one amino-functional silicon compound.

The preparation of the inventive polyolefin compounds is preferably based on starting materials from the following series
(i) polypropylene (PP) or polyethylene (PE),
(ii) maleic-anhydride-modified polypropylene or maleic-anhydride-modified polyethylene,
(iii) inorganic or organic filler,
(iv) at least one aminosilane and/or aminosiloxane, and
(v) where appropriate, stabilizers with respect to heat, metal ions, and UV exposure, and also processing aids, such as silicone oils, paraffins, fatty acids—to mention just a few examples.

Inventive compounds are generally based on commercially available types of polyolefin as component (i), in particular PE or else PP.

Component (ii) is preferably based on types of PP and of PE which have been specifically grafted with maleic anhydride. This material, too, is commercially available.

Inventive compounds preferably have a proportion of from 0.1 to 15 parts by weight of components (ii), based on the entire polymer content. The proportion of component (ii) preferably used in the inventive compounds is from 0.5 to 12 parts by weight, very particularly preferably from 0.8 to 10 parts by weight, in particular from 1 to 6 parts by weight, based on 100 parts by weight of total polymer content.

As component (iii), i.e. filler, inventive compounds preferably comprise metals, metal oxides or metal hydroxides, such as magnesium hydroxide, aluminum hydroxide, antimony oxide, silicon oxides in any of the forms and modifications, e.g. silicon dioxide, silicates, organoclays, or else calcium carbonate, or else natural materials, such as wood, natural fibers, biodegradable fillers, or else combinations of the abovementioned fillers, suitable forms in which these fillers are used ranging from powders to nanoparticles.

The inventive compounds, which are highly filled systems, advantageously have from 30 to 85% by weight filler content, preferably from 40 to 80% by weight, particularly preferably from 50 to 75% by weight, in particular from 55 to 70% by weight, based on the compounds.

The inventive, highly filled polyolefin compounds are moreover preferably based on the use of at least one amino-functional silicon compound from the following series:
a) aminosilane of the general formula I

R¹—Si(CH₃)ₓ(Z)₃₋ₓ (I),

where the groups Z are identical or different and Z is an alkoxy group having from 1 to 4 carbon atoms, x is 0 or 1, and R¹ is an amino group of the formula H₂N—[(CH₂)₂NH]_{y}—(CH₂)₃—, where y is 0 or 1 or 2,
b) aminosilane of the general formula II

R²(₂₋ᵥ₎NHᵥ—(CH₂)₃—Si(CH₃)ₓ(Z)₃₋ₓ (II),

where the groups Z are identical or different and Z is an alkoxy group having from 1 to 4 carbon atoms, x and v, independently, are 0 or 1, the groups R² are identical or different, and R² is a linear, cyclic, or branched alkyl group having from 1 to 20 carbon atoms or an aryl group having from 6 to 12 carbon atoms,
c) bisaminosilane of the general formula (III)

(Z)₃Si(CH₂)₃[NH(CH₂)₂]_{w}NH[(CH₂)₂NH]_{z}(CH₂)₃Si(Z)₃ (III),

where the groups Z are identical or different and Z is an alkoxy group having from 1 to 4 carbon atoms, and w and z, independently of one another, are 0, 1 or 2,
d) aminosiloxane oligomers of the general formulae (IV) and (V),

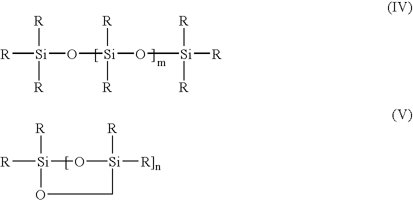

where the substituents R are composed of
aminopropyl-functional groups of the formula —(CH₂)₃—NH₂ or —(CH₂)₃—NHR′ or —(CH₂)₃—NH(CH₂)₂—NH₂ or —(CH₂)₃—NH(CH₂)₂—NH(CH₂)₂—NH₂, where R′ is a linear, branched, or cyclic alkyl group having from 1 to 18 carbon atoms, or an aryl group having from 6 to 12 carbon atoms, and
methoxy, ethoxy and/or propoxy groups, and
where appropriate, alkyl, alkenyl, isoalkyl or cycloalkyl groups having from 1 to 18 carbon atoms, and/or aryl groups having from 6 to 12 carbon atoms,
   where at most one aminopropyl-functional group has bonding to a silicon atom and the degree of oligomerization for compounds of the general formula IV is in the range 2≦m≦30, and that for compounds of the general formula V is 3≦n≦16, and the quotient derived from the molar Si/alkoxy group ratio is preferably ≧0.5, these generally being obtainable via hydrolysis, condensation or coconsensation of primary and/or secondary aminosilanes, and also, where appropriate, of organofunctional, hydrolyzable silanes, and may take the form of linear or cyclic structures, or else of a three-dimensional structure,
e) a mixture composed of at least two of the abovementioned amino-functional silicon compounds,
   or
f) a mixture of at least one amino-functional silicon compound with at least one vinyl silane and/or alkyl silane. Vinyl silanes or alkyl silanes suitable here are in particular vinyltrimethoxysilane, vinyltriethoxysilane, methyltrimethoxysilane, methyltriethoxysilane, vinyltris(2-methoxyethoxy)silane, isopropyltri-methoxysilane, n-propyltrimethoxysilane, isopropyltriethoxysilane, n-propyltriethoxysilane, isobutyltrimethoxysilane, n-butyltrimethoxysilane, isobutyltriethoxysilane, n-butyltriethoxysilane, isooctyltriethoxysilane, n-octyltriethoxysilane, hexadecyltrimethoxysilane, and octadecyltrimethoxysilane.

The present invention also provides a process for preparing inventive highly filled polyolefin compounds, which comprises
(A) combining components (i), (ii), (iii), (iv) and, where appropriate, (v) in a heated mixing assembly with extrusion apparatus, mixing these, extruding the melt, and obtaining pellets, or
(B) first mixing or coating component (iii) with component (iv) in an optionally heatable stirred tank, as can be found by way of example in EP 0 955 344 A2, and also combining components (i) and (ii), and also, where appropriate, (v), in a heated mixing assembly with extrusion apparatus, and mixing these, and then adding the mixture of components (iii) and (iv) produced in the reactor to, and incorporating it into, the polymer mixture, extruding the melt, and obtaining the pellets.

By way of example—but not exclusively—the present invention can use PP or PE, e.g. Hifax CA 10 A, as preferred component (i).

As component (ii), preference is generally given to appropriate MAH-grafted polyolefins, e.g. Exxelor PO 1020.

Components (iii) used in the inventive process preferably comprises a filler from the following series: magnesium droxide, e.g. Magnifin H7, aluminum hydroxide, silicon dioxide, antimony dioxide, calcicum carbonate—to mention just a few possibilities.

The inventive process also advantageously uses from 0.01 to 5% by weight, preferably from 0.05 to 3% by weight, particularly preferably from 0.1 to 2% by weight, in particular from 0.5 to 1.5% by weight, of component (iv), based on the compound.

The component (iv) used in the inventive process particularly preferably comprises an amino-functional silicon compound from the following series: 3-aminopropyltrimethoxysilane (AMMO): [H₂N(CH₂)₃Si(OCH₃)₃], 3-aminopropyltri-ethoxysilane (AMEO): [H₂N(CH₂)₃Si(OC₂H₅)₃], N-aminoethyl-3-aminopropyltri-methoxysilane (DAMO): [H₂N(CH₂)₂NH(CH₂)₃Si(OCH₃)₃], N-aminoethyl-N′-aminoethyl-3-aminopropyltrimethoxysilane (TRIAMO): [H₂N(CH₂)₂NH(CH₂)₂NH(CH₂)₃Si(OCH₃)₃], 3-[N-butylamino]propyltrimethoxysilane, 3-[N-butylamino]propyltriethoxysilane, 3-[N-cyclohexylamino]propyltrimethoxysilane, or what is known as a “bisaminosilane”, e.g. “bisAMEO”: [(H₅C₂O)₃Si(CH₂)₃NH(CH₂)₃Si(OC₂H₅)₃], or “bisAMMO”: [(H₃CO)₃Si(CH₂)₃NH(CH₂)₃Si(OCH₃)₃].

For the purposes of the present invention, other bisaminosilanes are those found in EP 1 031 593 B1, where a method for the hydrolysis or condensation or cocondensation of primary and secondary aminosilanes can also be found. Examples of aminosiloxanes can also be found in EP 1 031 593 B1.

The entire content of the citations listed above or below is at the same time expressly incorporated into the present application by way of reference.

Examples of other siloxanes for the purposes of the present invention, which are generally obtainable via hydrolysis or condensation or cocondensation of appropriate aminosilane or organosilane compounds, together with methods for the preparation of appropriate siloxanes, may in particular be found in the European patents EP 0 716 127 A2, EP 0 716 128 A2, EP 0 832 911 A1, EP 0 953 591 B1, and EP 0 997469 A2.

However, the inventive process can also use mixtures composed of said amino-functional silicon compounds. Mixtures composed of the specified aminosilanes and/or aminosiloxanes may generally be prepared via addition of each of the individual components, with good mixing.

The procedure for the inventive use of aqueous aminosilane systems or aqueous aminosiloxane systems as component (iv) is preferably process variant (B).

For the use of non-aqueous aminosilane systems or non-aqueous aminosiloxane systems as component (iv), preference is given to process variant (A), but it is also possible here to operate advantageously with variant (B).

The specified aminosilane systems or specified aminosiloxane systems may moreover be used according to the invention in “dry”, i.e. supported form. For this, a suitable procedure uses variant (A) of the inventive process. However, it is also possible to begin with physical mixing of a “dry” aminosilane system or “dry” aminosiloxane system with the filler to be used, and then to use process variant (B). These “dry” silane systems are generally obtainable via mixing of a suitable ratio of the aminosilanes or aminosiloxanes, both of these usually being liquid, with a suitable, i.e. porous, absorbent, pulverulent, solid support material, e.g. fumed or precipitated silica, carbon black, wax, or foamed polyolefins.

A highly filled polyolefin compound may generally be prepared via mixing of the polymer components and of the respective filler in a compounding kneader. For this, polymer pellets on the one hand, and the filler on the other hand, are generally fed, in such a way as to enable the desired filler level to be maintained, via two feed devices into the mixer, which has been heated to a temperature above the melting point of the polymer. The amino-functional silicon compound may then be incorporated into the composition as in process variant (A). However, according to the invention use may also be made of a filler coated with an amino-functional silicon compound, cf. process variant (B). Processing aids known per se, and also stabilizers, may also be admixed with the mixture for the compound. Filler level generally means the relationship by weight between filler and compounded material, for example at 50 parts by weight of polymer and 50 parts by weight of filler in the compound the filler level is 50%. The compound emerging from the mixer is then generally pelletized in a manner known per se, and may be processed, for example using an injection-molding machine, to give semifinished or finished products, i.e. moldings.

Examples of ready-to-use items produced, by way of example, via extrusion or injection molding are a very wide variety of housings for electronic equipment or parts for motor vehicles, e.g. cables, wheel caps, and fan housings, to mention just a few.

The highly filled polyolefin compounds obtainable by the inventive method generally have not only good strength but also good impact resistance.

The present invention therefore also provides highly filled polyolefin compounds, in particular PP compounds and PE compounds, which are obtainable by the inventive process.

The invention also provides the use of at least one amino-functional silicon compound for the inventive production of highly filled polyolefin compounds, in particular for PP compounds and for PE compounds.

The invention also provides the use of inventive compounds for producing polyolefin moldings.

For example, inventive compounds are particularly advantageously used for producing flame-retardant compounds for cables, and these materials can in particular be used in automotive construction.

The present invention therefore also provides items whose production is based on the use of inventive compounds.

The examples below provide more detailed illustration of the present invention but do not restrict its subject matter.

### EXAMPLES

### Comparative Example

The following typical mixing specification is used for testing:

97 parts of PP (HiFax CA 10A, BASELL)

3 parts of maleic anhydride-modified PP (Exxetor PO 1020; ExxonMobil Chemicals)

183 parts of magnesium hydroxide (Magnifin H7, Albemarle)

Preparation:

The polymer components are processed together with the filler in an extruder to give the compounded material, and test specimens are prepared therefrom, results cf. Table 1.

### Inventive Example 1

The following typical mixing specification is used for testing:

97 parts of PP (HiFax CA 10A, BASELL)

3 parts of maleic anhydride-modified PP (Exxetor PO 1020; ExxonMobil Chemicals)

183 parts of magnesium hydroxide (Magnifin H7, Albemarle)

2 parts of N-n-butyl-3-aminopropyltrimethoxysilane (DYNASYLAN® 1189; Degussa)

Preparation:

The filler is coated with the aminosilane in a Lödige mixer. The coating of the filler with the aminosilane takes place at about 60° C. After about 20 minutes of mixing time, the filler is dried at 60° C. and 400 mbar reduced pressure. This gives a white free-flowing powder. The polymer components are then processed together with the aminosilane-coated filler in a twin-screw extruder to give the compound. Strips are produced from a portion of the compound in a single-screw extruder. Test specimens are stamped out from these strips for the tensile tests and water absorption. Flow properties are determined on the compound produced in the twin-screw extruder.

TABLE 1
The following properties were determined on the test specimens
produced in the comparative example and in inventive example 1:

| | Test specimen from | Test specimen from |
|---|---|---|
| Tests | comparative example | inventive example 1 |
| “Melt flow ratio” to EN | 5 | 25 |
| ISO 1133 [g/10 min] | | |
| Tensile strength to EN ISO | 9.6 | 9.5 |
| 527 [MPa] | | |
| Tensile strain at break to | 36 | 322 |
| EN ISO 527 [%] | | |
| Water absorption to EN | 0.4478 | 0.1278 |
| 60811-1-3 [mg/cm²] | | |

1. A highly filled polyolefin compound, comprising a maleic-anhydride-modified polyolefin and at least one amino-functional silicon compound, from the following series:
a) an aminosilane of the general formula I
R¹—Si(CH₃)ₓ(Z)₃₋ₓ (I),
where the groups Z are identical or different and Z is an alkoxy group having from 1 to 4 carbon atoms, x is 0 or 1, and R¹ is an amino group of the formula H₂N—[(CH₂)₂NH]_{y}—(CH₂)₃—, where y is 0 or 1 or 2,
b) an aminosilane of the general formula II
R²_{(2-y)}NH_{y}—(CH₂)₃—Si(CH₃)ₓ(Z)₃₋ₓ (II),
where the groups Z are identical or different and Z is an alkoxy group having from 1 to 4 carbon atoms, x and v, independently, are 0 or 1, the groups R² are identical or different, and R² is a linear, cyclic, or branched alkyl group having from 1 to 20 carbon atoms,
c) a bisaminosilane of the general formula (III)
(Z)₃Si(CH₂)₃[NH(CH₂)₂]_{w}[(CH₂)₂NH]_{z}(CH₂)₃Si(Z)₃ (III),
where the groups Z are identical or different and Z is an alkoxy group having from 1 to 4 carbon atoms, and w and z, independently of one another, are 0, 1 or 2,
d) aminosiloxane oligomers of the general formulae (IV) and (V), 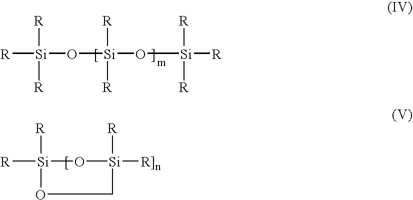
where the substituents R are composed of
aminopropyl-functional groups of the formula —(CH₂)₃—NH₂ or —(CH₂)₃—NHR′ or —(CH₂)₃—NH(CH₂)₂—NH₂ or —(CH₂)₃—NH(CH₂)₂—NH(CH₂)₂—NH₂, where R′ is a linear, branched, or cyclic alkyl group having from 1 to 18 carbon atoms, or an aryl group having from 6 to 12 carbon atoms, and methoxy, ethoxy and/or propoxy groups, and where appropriate, alkyl, alkenyl, isoalkyl or cycloalkyl groups having from 1 to 18 carbon atoms, and/or aryl groups having from 6 to 12 carbon atoms,
where at most one aminopropyl-functional group has bonding to a silicon atom and the degree of oligomerization for compounds of the general formula IV is in the range 2≦m≦30, and that for compounds of the general formula V is 3≦n≦16,
e) a mixture composed of at least two of the amino-functional silicon compounds selected from the group of an aminosilane of the general formula,
R¹—Si(CH₃)ₓ(Z)_{3-x,}
where the groups Z are identical or different and Z is an alkoxy group having from 1 to 4 carbon atoms, x is 0 or 1, and R¹ is an amino group of the formula H₂N—[(CH₂)₂NH]_{y}—(CH₂)₃—, where y is 0 or 1 or 2,
an aminosilane of the general formula
R²₍₂₋ᵥ₎NH_{y}—(CH₂)₃—Si(CH₃)ₓ,
where the groups Z are identical or different and Z is an alkoxy group having from 1 to 4 carbon atoms, x and v, independently, are 0 or 1, the groups R² are identical or different, and R² is a linear, cyclic, or branched alkyl group having from 1 to 20 carbon atoms or an aryl group having from 6 to 12 carbon atoms,
a bisaminosilane of the said general formula (III), and
the aminosiloxane oligomers of the said general formulae (IV) and (V), or
f) a mixture of at least one amino-functional silicon compound with at least one vinyl silane and/or alkyl silane.

2. The highly filled compound as claimed in claim 1, the preparation of which is based on starting materials from the following series
(i) polypropylene (PP) or polyethylene (PE),
(ii) maleic-anhydride-modified polypropylene or maleic-anhydride-modified polyethylene,
(iii) filler,
(iv) at least one aminosilane and/or aminosiloxane according to a) to f), and
(v) where appropriate, stabilizers and processing aids.

3. The highly filled compound as claimed in claim 1,
wherein
the proportion of component (ii) is from 0.1 to 10 parts by weight, based on the entire polymer content.

4. The highly filled compound as claimed in claim 1,
wherein
metal powders, metal oxides, metal hydroxides, and/or biomaterials are present as fillers.

5. The highly filled compound as claimed in claim 4,
wherein
magnesium hydroxide, silicon dioxide, silicates, organoclays, aluminum hydroxide, antimony oxide, calcium carbonate, wood, natural fibers, or biodegradable fillers are present.

6. The highly filled compound as claimed in claim 1,
wherein
the filler content is from 30 to 85% by weight, based on the compound.

7. The highly filled compound as claimed in claim 1,
wherein
the content of component (iv) is from 0.01 to 5% by weight, based on the compound.

8. (canceled)

9. A process for preparing a polyolefin compound as claimed in claim 1,
which comprises
(A) combining components (i), (ii), (iii), (iv) and, where appropriate, (v) in a heated mixing assembly with extrusion apparatus, mixing these, extruding the melt, and obtaining pellets, or
(B) first coating or mixing component (iii) with component (iv) in a stirred tank, and also combining components (i) and (ii) and also, where appropriate, (v), in a heated mixing assembly with extrusion apparatus, and mixing these, and then adding the mixture of components (iii) and (iv) produced in the reactor to, and incorporating it into, the polymer mixture, extruding the melt, and obtaining the pellets.

10. A polyolefin compound obtained from the process of claim 9.

11. (canceled)

12. A polyolefin molding comprising a highly filled polyolefin compound as claimed in claim 1.

13. A flame-retardant compound for cables comprising a polyolefin compound as claimed in claim 1.

14. (canceled)
